(19) United States
(12) Patent Application Publication
(10) Pub. No.: US 2013/0021448 A1
(43) Pub. Date: Jan. 24, 2013

(54) STEREOSCOPIC THREE-DIMENSIONAL CAMERA RIGS

(71) Applicant: B. Sean Fairburn, Ponchatoula, LA (US)

(72) Inventor: B. Sean Fairburn, Ponchatoula, LA (US)

(73) Assignee: MULTIPLE INTEROCULAR 3-D, L.L.C., Ponchatoula, LA (US)

(21) Appl. No.: 13/405,191

(22) Filed: Feb. 24, 2012

Related U.S. Application Data
(60) Provisional application No. 61/446,418, filed on Feb. 24, 2011.
(60) Provisional application No. 61/542,695, filed on Oct. 3, 2011.
(60) Provisional application No. 61/542,711, filed on Oct. 3, 2011.

(51) Int. Cl. H04N 13/02

(52) U.S. Cl. 348/47; 348/E13.074

(57) ABSTRACT

A three-dimensional camera rig includes multiple lenses located along a mounting mechanism, where the multiple lenses are separated at an interocular distance along the mounting mechanism necessary to capture a three-dimensional image capable of distribution, and where the three-dimensional image is viewable in a plurality of formats.

### CROSS-REFERENCE TO RELATED APPLICATIONS

This application is a non-provisional of U.S. Provisional Application No. 61/446,418, filed on Feb. 24, 2011, and entitled: “Three-Dimensional Camera Rigs T, V, POV, QUAD, DNA, BEAMSPLITTER, AND MIO MOBILE,” U.S. Provisional Application No. 61/542,695, filed on Oct. 3, 2011, and entitled: “Three-Dimensional Camera Rigs T, V, POV, QUAD, and DNA,” U.S. Provisional Application No. 61/542,711, filed on Oct. 3, 2011, and entitled: “Three-Dimensional Camera Rigs 7 and YOKE.” Accordingly, this application claims priority to U.S. Provisional Application No. 61/446,418, 61/542,695, and 61/542,711 under 35 U.S.C. §119(e). U.S. Provisional Application No. 61/446,418, 61/542,695, and 61/542,711 are hereby incorporated by reference in its entirety.

### BACKGROUND

In moviemaking, the term 3-D (or 3D or S3D) is used to describe any visual presentation system that attempts to record two distinct and separate vectors or angles of a scene to maintain or recreate moving images of a third dimension, which is the illusion of depth as seen by a viewer.

Stereoscopy is a widely accepted method for capturing and delivering 3-D video images. Stereoscopy involves capturing stereo pairs in a two-view setup, with cameras mounted often roughly at the inter-pupil distance of human eyes. This technique usually involves filming two images simultaneously, with two cameras.

There are side by side 3-D rig shooting methods that uses two cameras positioned side by side that have a limited minimum InterOcular (IO) based on the size of cameras used.

There are beam-splitter rig shooting methods that use two cameras positioned at a 90 degree angle to one another with the use of a 50/50 beam-splitter mirror Minimum IO would be zero out to the widest point capable by the rig.

### SUMMARY

In general, in one aspect, the invention relates to a three-dimensional camera rig comprising a plurality of lenses located along a mounting mechanism, wherein the plurality of lenses are separated at an interocular distance along the mounting mechanism necessary to capture a three-dimensional image capable of distribution, and wherein the three-dimensional image is viewable in a plurality of formats.

In general, in one aspect, the invention relates to a three-dimensional camera rig, comprising a rigid mounting mechanism, and three or more lenses mounted on the rigid mounting mechanism at multiple interaxial distances and configured to capture a three dimensional image capable of distribution.

In general, in one aspect, the invention relates to a method for capturing a three-dimensional image comprising preparing a three-dimensional camera rig comprising three or more lenses mounted on a rigid mounting mechanism at multiple interaxial distances, capturing, using the three or more lenses, a three dimensional image capable of distribution.

Other aspects of the invention will be apparent from the following detailed description and the appended claims.

### BRIEF DESCRIPTION OF THE DRAWINGS

FIGS. 1-5 show possible layout of cameras in accordance with one or more embodiments of the invention.

FIGS. 6-17 show a rig with multiple cameras in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

This invention introduces a new shooting method that may use a combination of side by side and beam-splitter methods and enhancements to stereoscopic 3-D camera rigs.

First consider a 40 ft screen in a movie theater. If you sit 2.5 screen heights away and your eyes are 2.75 inches apart, then the ratio of viewer distance, viewer interocular, to the screen size is 175 to 1 (screen (175) to your eyes (1)). Theaters need a small IO to fit properly with the scale of the screen to viewer ratio.

Now consider the same images shot the same way on a 24 inch computer screen on your desk. The field of view may be similar, but your IO distance is still 2.75 and in relationship is 9 to 1 (screen (9) to your eyes (1)). In scale, your eyes are much bigger and farther apart as the screen gets smaller. So the JO must get wider and 3-D stronger or the 3-D may appear insignificant or non existent. Now this difference in ratios is usually unimportant when viewing 2D content shot by a single lens which projects only a single eye's worth of information, but with 3-D the second eye provides the depth that our brains put together as a 3-D scene and this depth is dependent on the ratio. The bottom line is that for each range of display size the footage will need to be corrected to maintain the effectiveness of the 3-D content. For screen sizes from 40 ft down to 12 ft a single 3-D image may work but for smaller size displays 12-4 ft and 4-1 ft the image will need to be shot with larger distance between the lenses in the first place. This technique gives the viewer the impression that the whole scene is miniature but that will be necessary to obtain the 3-D effect for smaller screens. Mobile devices may require a wide IO to be viewed properly on such a small screen.

Distance to subject in the shot and distance to background as well as wide versus longer zoom lens shots all have a dramatic effect on the strength and quality of the 3D. Even when done well it will only work for one screen range.

With the recent improvements in digital technology, the concept of delivering 3-D content to the masses is being seen as a legitimate business model. Many theaters are offering projection of 3-D movies. There is a market for delivering 3-D video to the home and to the screens of mobile devices, both of which may be receiving a signal via wired or wireless connectivity.

Efforts are currently taking place to define the parameters of a stereoscopic 3-D mastering standard for content viewed in the home. Standards are being discussed for distributing 3-D content via broadcast, cable, satellite, packaged media and the Internet to be played-out on televisions, computer screens, mobile devices, and tethered displays.

In one or more embodiments of the invention, a new stereoscopic 3-D shooting method is described. Multiple InterOcular 3-D (MIO 3-D) which uses three or more cameras to gather three or more IOs. As used herein, a camera is known to include a lens and the term camera (with a lens) and a lens may be used interchangeably.

The distance between the cameras is often referred to as the InterAxial (IA) or the IO, and the point the images overlap exactly is called the convergence point. MIO 3-D uses 3-D multi-view and captures three or more cameras working to gather multiple IO distances at the same time. MIO 3-D uses an array of potentially many cameras or many lenses and sensors built into one casing or body or housing or rig to capture a 3-D scene (or a portion of a 3-D scene such as a shot) through multiple independent video streams. Pairs can be selected later from multiple choices available to determine the best pair for a given part of the shot and a given screen size. In one or more embodiments Stereoscopic MIO 3-D has redundancy of IO pairs allowing for possible problems, like mud on the lens, without loosing 3-D.

In one or more embodiments of the invention, multiple stereo pairs shot in MIO 3-D may be able to accommodate effective 3-D and various screen sizes properly as well as fast-moving action in the shot. After individual images are captured using MIO 3-D, multiple stereo pairs are available to editors to decide which pair offers the best IO relationship for the given part of the shot. Editors will have choices never before possible. In one or more of the embodiments MIO 3-D may allow distributors and moviemakers to have more options as to re-purposing a show shot with MIO 3-D into various markets with differing predominant 3-D screen sizes. In one or more embodiments of the invention viewers will be able to choose which Stereo Pair to watch from three or more options available: strong, medium, or mild 3-D or 2D of just one camera view.

In one or more embodiments of the invention, the invention relates to 3-D rig design directed to work in consumer electronics, broadcast environment, live image magnification for houses of worship and concerts, internet, military air and ground applications, among others. All these purposes having multiple screen sizes to be fed with stereo images.

In one or more embodiments of the invention, an optical axis is defined as a line passing through the center of a lens that is also normal to the plane of the lens. The optical axis may define a path of a light beam coming from an object and arriving at the lens. In other words, an optical axis may be the line corresponding to the direction in which the lens or camera is pointed at. In one or more embodiments of the invention, multiple lenses have multiple optical axes that are co-planar. The plane encompassing these multiple optical axes is defined as the optical plane.

FIG. 1 shows how three cameras with no spacing create two IO combinations with redundancy. Small IO's from AB same distance as BC, but AC is a wide IO. This configuration is described as ABC.

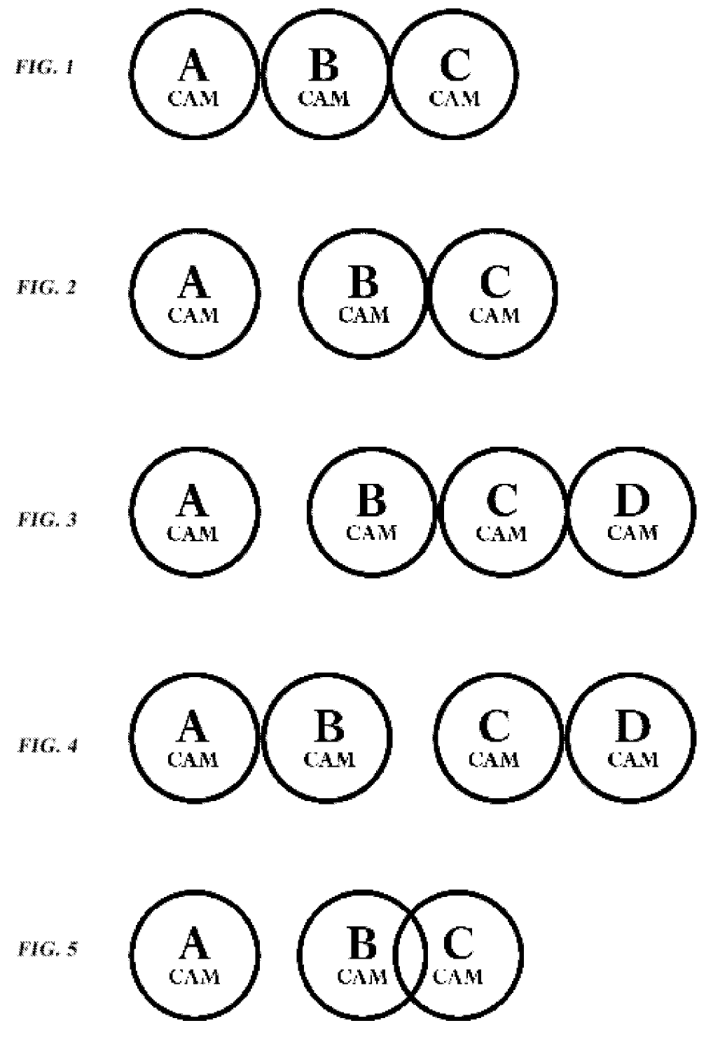

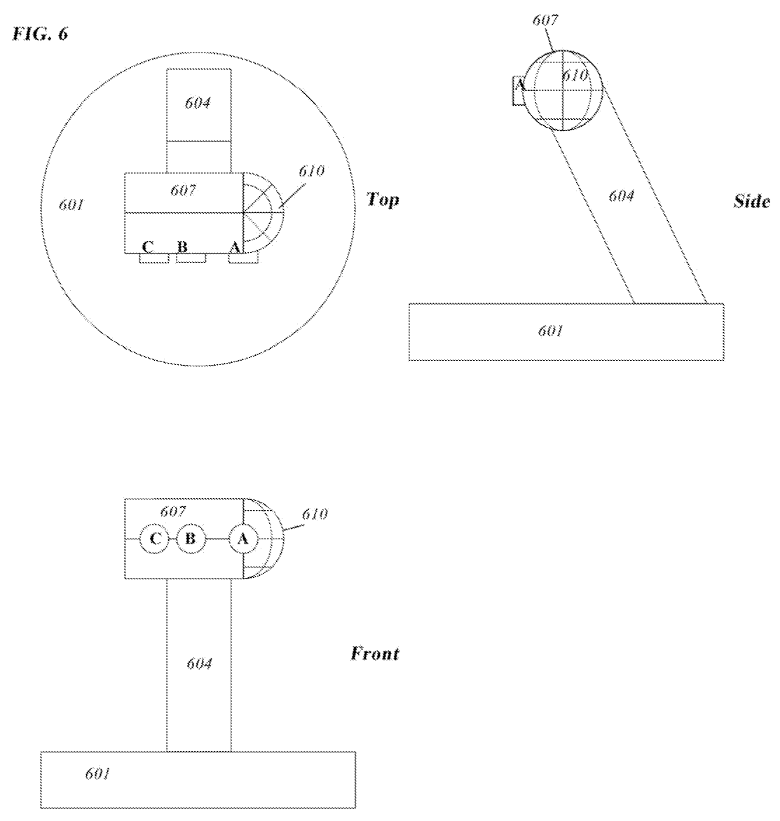

In one or more embodiments of the invention, MIO 3-D is to be used to capture the 3-D video content which involves a Rig or camera with at least three lenses at three interocular distances, as shown FIG. 2. FIG. 2 shows how three cameras with offset spacing create three IO combinations with no redundancy. Small IO from BC, Medium IO from AB and Wide IO from AC. This configuration is described as A_BC. In one or more embodiments of the invention, each lens may be a part of an autonomous camera and all three cameras make a rig to capture images simultaneously, thus achieving the same effect as a single camera with three lenses.

In this embodiment of the invention, as shown by the rig in FIG. 16 which is shown and described below, there are three 40 mm lenses that are 5 mm between closest and 20 mm between farthest. For this example, the farthest left lens is A (closest to viewer), the middle lens is B, and the farthest right lens is C. Accordingly, A to B=60 mm IO distance, A to C=105 mm IO distance, and B to C=45 mm IO distance. This configuration can offer three IO's from which to pick. In one or more embodiments of the invention, A to B IO distance is the same as the B to C IO distance, but the rig still provides multiple IO distances since the A to C IO distance is different from the A to B and B to C IO distances. This configuration can offer two IO's to pick from with redundancy.

As discussed above, the three dimensional image is formed from images captured by one pair of lenses of the three lenses (e.g., A and B, A and C, or B and C). Further, as discussed above, a specific pair may be chosen based on the size of the screen on which the image is to be displayed. For example, if the image is to be displayed on a small screen (e.g., a screen of a mobile phone), images from a pair of lenses with a wide IO distance (e.g., A and C) may be used to form the three dimensional image. In one or more embodiments of the invention, having three IO distances may facilitate enhanced optional image angles in post-production to generate three dimensional images with a proper or desired scene depth.

In one or more embodiments of the invention, images shot from lenses with a larger IO distance create a larger scene depth than those shot with a smaller IO distance. In one or more embodiments of the invention, the different IO distances may be used to create a simultaneous deeper and shallower scene depth than would be expected when shot using only one IO.

In one or more embodiments of the invention, images shot from different pairs of lenses have different vectors of the scene. In this specification, a vector is defined as the angle viewing the objects in the scene in relationship to the scene. One pair of lenses may capture a scale of a scene different to another pair of lenses. In one or more embodiments of the invention, images from a pair of lenses may be chosen based on the Vector and scale the pair of lenses provide. Accordingly the extra lenses may be used for redundancy purposes for shot and IO pairs.

As discussed above, the optical axes of the lenses in a camera rig may be coplanar. In one of more embodiments of the invention, the optical axes of the lenses may also be parallel.

In one or more embodiments of the invention, one or more lenses may be toed-in, defined as having an optical axis intersects with the optical axes of the other lenses at a convergence point.

With a three or more lens rig, multiple shooting styles can be achieved simultaneously parallel and converged from side-by-side and beamsplitter configurations. In one or more embodiments of the invention, having images with different IO distances will provide more options for the editors in post-production and the viewers of the 3-D content. For example, in many cases it may be beneficial to film a close-up object using a close IO pair of toed-in lenses as the corresponding three-dimensional image may be more easily viewable. On the other hand, when the scene shifts to a distant object, the three-dimensional image may then be formed from a pair of lenses that are farther apart having a wider IO.

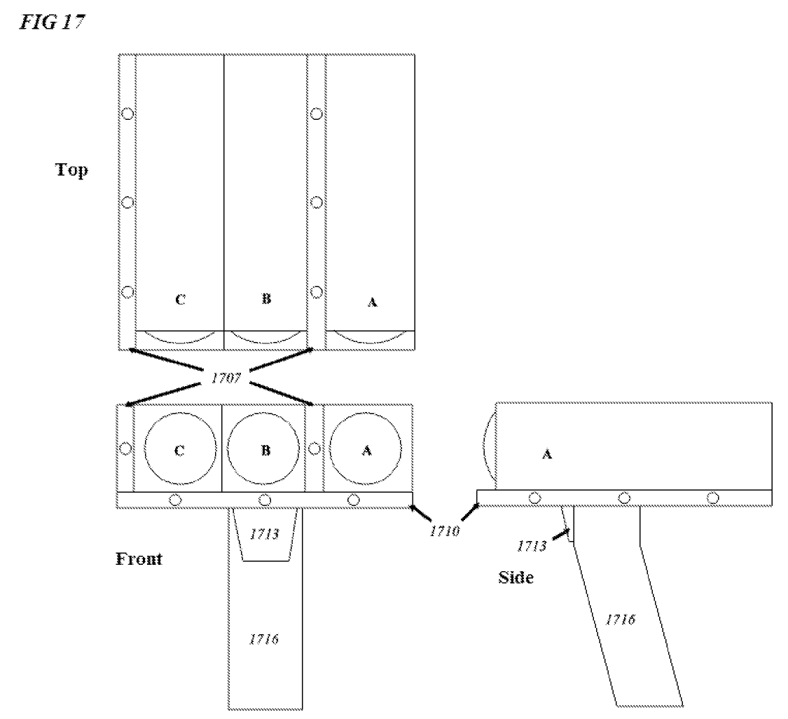

In one or more embodiments of the invention, the rig used to capture video content involves the use of a universal mounting plate may be the one shown in FIG. 17 and described below. The Fairburn 3D MultiPlate™ 3×3, 2×3, 1×3, accommodate mounting video or still cameras to a platform and provide specific IO distances available for 3-D stereoscopic work as well as panoramic or 360 degree image capture platform work. Examples of some of the layouts are shown in FIG. 1, FIG. 2, FIG. 3, FIG. 4, and FIG. 5.

FIG. 3 shows how four cameras with offset spacing create six IO combinations with some redundancy in accordance with one or more embodiments of the invention. Small IO from BC and CD, Medium IO from AB and BD and Wide IO from AC and AD. This configuration is described as A_BCD.

FIG. 4 shows how four cameras with offset spacing create six IO combinations with redundancy in accordance with one or more embodiments of the invention. Small IO from AB and CD, Medium IO from BC, Wide IO from AC and BD and Extra Wide IO from AD. This configuration is described as AB_CD.

FIG. 5 shows how three cameras with offset spacing create three IO combinations with no redundancy in accordance with one or more embodiments of the invention. Used on a beam-splitter to achieve Small IO from BC, Medium IO from AB and Wide IO from AC. This configuration is Described as A_BC. In this case B may overlap A or C to create smaller IO than would be physically possible if placed side by side.

Other examples include cameras mounted on other devices that can be mobile rigs, as shown below.

FIG. 6 shows a rig shaped like the letter “T” and is referred to as Rig #1 in accordance with one or more embodiments of the invention. Rig #1 may be made from material such as 6061 aluminum hardened anodized coating. FIG. 6 shows a top view, front view, and a side view in accordance with one or more embodiments of the invention. FIG. 6 shows base (601), which is 10″ diameter 1″ tall in accordance with one or more embodiments of the invention. FIG. 6 also shows a pivoting angled riser arm (604) defined as a tube providing support for 270 degree tilting camera pod (607) in accordance with one or more embodiments of the invention. The camera pod (607) is defined as an enclosure for cameras parts and lenses in accordance with one or more embodiments of the invention. FIG. 6 includes a convergence ball (610), which is a lateral rotating housing for camera sensor and lens. In one or more embodiments of the invention, base (601) holds up riser (604) holding in position camera pod (607) with camera “B” and camera “C” in fixed parallel position. “A” camera is enclosed in a convergence ball 610. Together three cameras and lenses A, B, C with irregular spacing at nodal point of between 0.3″ and 6″ make up the head of Rig #1. Rig #1 may be remotely operated by connecting power, video and control cables to animate pan, tilt, convergence and focus, iris, and zoom. In accordance with one or more embodiments of the invention, Rig #1 is MIO 3-D fixed IO having three cameras and lenses, one lens convergeable and two lenses fixed. Cameras built into the rig. Rig #1 uses MIO 3-D shooting convention and camera displacement shown in FIG. 2 in accordance with one or more embodiments of the invention.

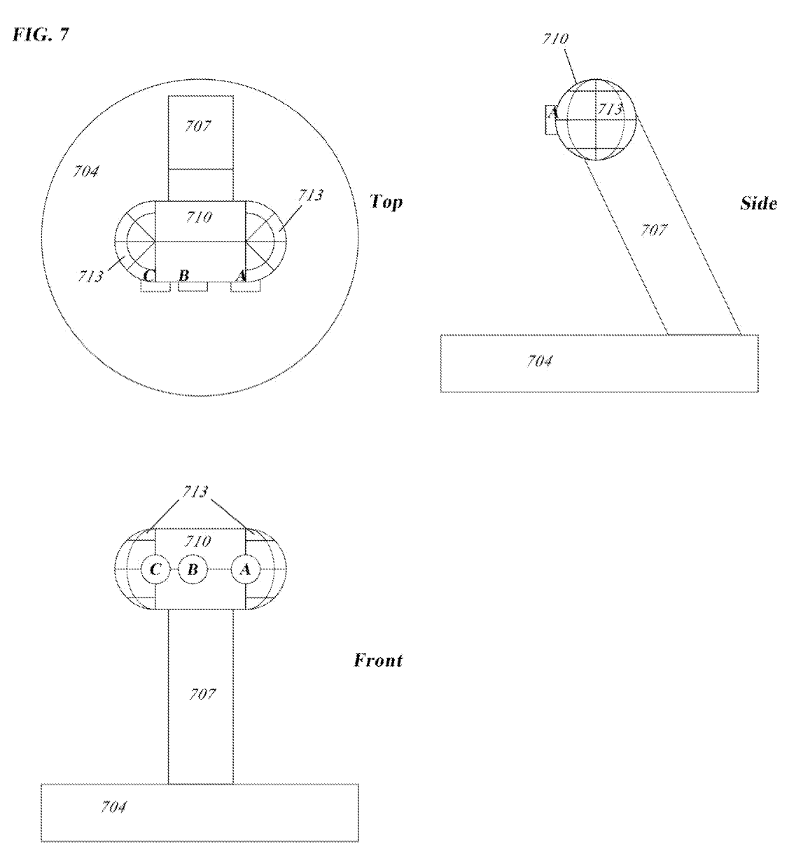

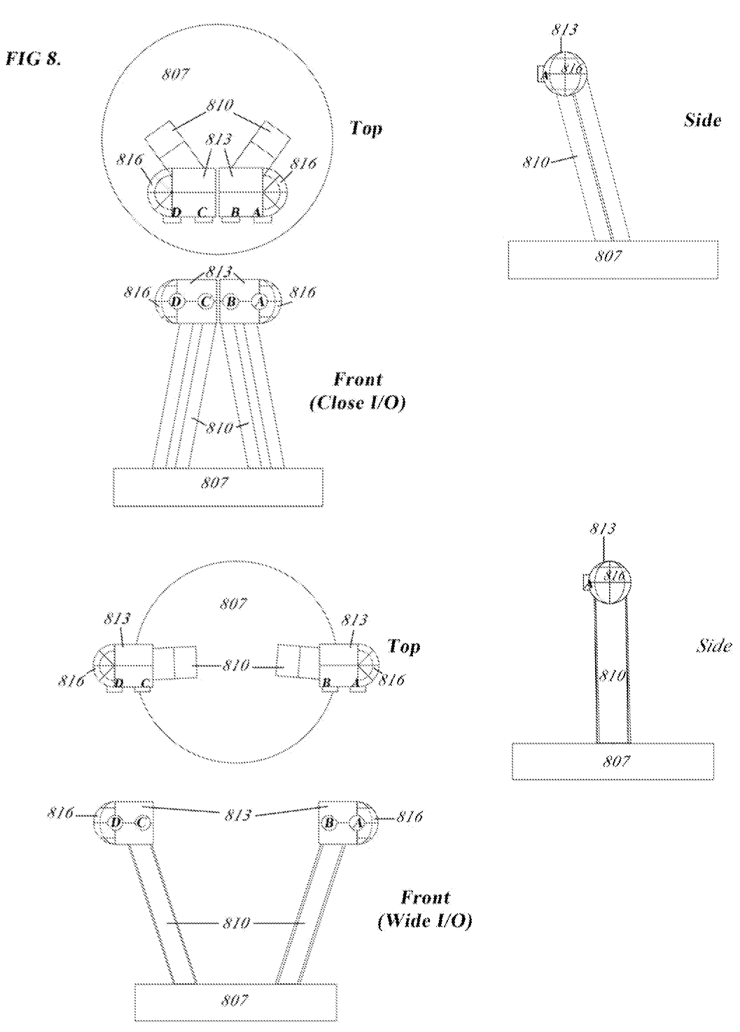

FIG. 7 shows a rig shaped like letter “T” and is referred to as Rig #2 (“T”) made from material such as 6061 aluminum hardened anodized coating. FIG. 7 shows a top view, front view, and a side view in accordance with one or more embodiments of the invention. FIG. 7 shows a base (701) that may be 10″ diameter 1″ tall in accordance with one or more embodiments of the invention. FIG. 7 shows a pivoting angled riser arm (704) defined as a tube providing support for 270 degree tilting camera pod (707). FIG. 7 shows a camera pod (707), which is defined as an enclosure for cameras parts and lenses in accordance with one or more embodiments of the invention. FIG. 7 shows a convergence ball (710) with a lateral rotating housing for camera sensor and lens in accordance with one or more embodiments of the invention. The base (701) supports pivoting angled riser arm (707) providing support for 270 degree tilting camera pod (710) and enclosure for cameras parts and lenses holding in fixed position camera “B”. “A” and “C” cameras are enclosed in a convergence ball (713) and lateral rotating housing for “A” and “C” camera sensor and lens.

Together three cameras and lenses A, B, C with irregular spacing at nodal point between 0.3″ and 6″ make up the head of Rig #2. Rig #2 is remotely operated by connecting power, video, and control cables to animate pan, tilt, convergence and focus, iris, and zoom. In accordance with one or more embodiments of the invention, Rig #2 is MIO 3-D fixed IO having three cameras and lenses, two lenses convergeable and one lenses fixed. Cameras are built into the rig. Rig #2 uses MIO 3-D shooting convention and camera displacement shown in FIG. 2 in accordance with one or more embodiments of the invention.

FIG. 8 is shaped like letter “V” and referred to as Rig #3 (“V”) in accordance with one or more embodiments of the invention. Rig #3 has variable MIO 3-D and convergence. FIG. 8 is made from material like 6061 aluminum hardened anodized coating or hard molded plastic in accordance with one or more embodiments of the invention. FIG. 8 shows a top view, front view, and a side view in accordance with one or more embodiments of the invention. FIG. 8 shows a base (807) that is 10″ diameter and 1″ tall in accordance with one or more embodiments of the invention. FIG. 8 shows dual pivoting angled riser arms (810) and 270 degree tilting camera pods (813) including an enclosure for cameras parts and lenses in accordance with one or more embodiments of the invention. Convergence ball (816) is defined as a lateral rotating housing for camera and lens in accordance with one or more embodiments of the invention. FIG. 8 shows base pans the rig and supports defined as a tube providing support for 270 degree tilting camera pods (813) in accordance with one or more embodiments of the invention. On left side from behind, holding in fixed position camera “B” while camera “A” is enclosed in a convergence ball (816), lateral rotating housing for “A”. On right side from behind, holding in fixed position camera “C” while camera “D” is enclosed in a convergence ball (816). Two separate camera pods working together making four cameras and lenses A B and C D with irregular spacing at nodal point of between 0.3″ and 12″ make up the head of Rig #3 to shoot MIO 3-D in accordance with one or more embodiments of the invention. Rig #3 is remotely operated by connecting power, video, and control cables to animate pan, tilt, convergence and focus, iris, and zoom in accordance with one or more embodiments of the invention. Rig #3 may be shaped like an upside down V for Small IO, Regular V for wide IO. In one embodiment of the invention, Rig #3 has variable IO distance along a tube or other mounting mechanism between the lenses and convergence shaped like an upside down “V” for small IO distance and a regular “V” for wide IO distance. Having four lenses—one fixed, one convergeable on each extended arm on each head. Heads come together to make close IO's. Heads move apart to make wide IO pairs. In one embodiment of the invention, Rig #3 is remotely operated. Cameras may be attached to a rig or built into the rig. Rig #3 uses MIO 3-D shooting convention and camera displacement shown in FIG. 4 in accordance with one or more embodiments of the invention.

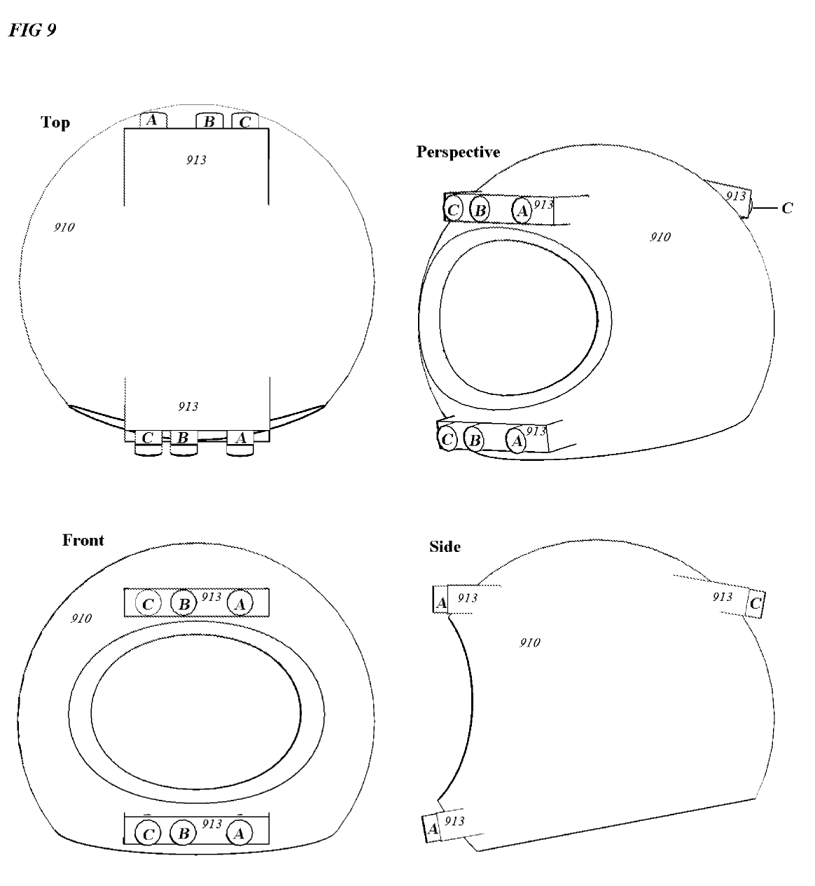

FIG. 9 shows MIO 3-D fixed IO integrated into or attached to a rider or player's helmet shooting first person action and is referred to as Rig #4 (“POV”). FIG. 9 shows a top view, front view, and a side view in accordance with one or more embodiments of the invention. FIG. 9 shows a helmet (910) made from materials such as fiberglass or hard molded plastic. Enclosure (913) attaches cameras to helmet. In accordance with one or more embodiments of the invention, three cameras A, B, C work together to provide irregular spacing and multiple 10. The cameras may be attached to a rig/helmet or built into the rig/helmet. FIG. 9 shows an example of 3D cameras integrated into molded fiberglass or hard plastic helmets in accordance with one or more embodiments of the invention. In one embodiment of the invention, Rig #4 has three or more cameras set that is fixed in an application or other mounting mechanism intended for integration into a helmet or other device located on the head of a person and or at the back of head, and or forehead, and or chin area. In one embodiment of the invention, Rig #4 is operated by wearer of helmet. In one embodiment of the invention, Rig #4 may be used in point of view applications for hands free 3D acquisition for training, or entertainment such as motocross, driving, flying, skydiving, skiing, flying, heavy equipment or other event involving first person action. In one embodiment of the invention, Rig #4 may be used by military and law enforcement to provide 3-D images of what they see. In one embodiment of the invention, Rig #4 may be adapted for work under water for SCUBA divers and search rescue teams. In one embodiment of the invention, Rig #4 may be used with thermal and night vision light amplification cameras as well as infra red images in 3D. Rig #4 uses MIO 3-D shooting convention and camera displacement shown in FIG. 2 in accordance with one or more embodiments of the invention.

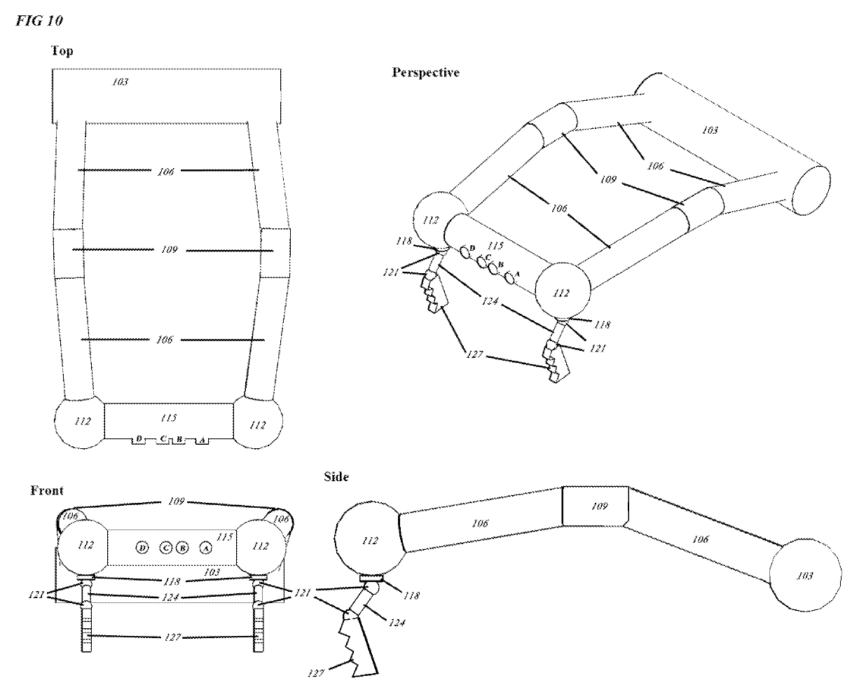

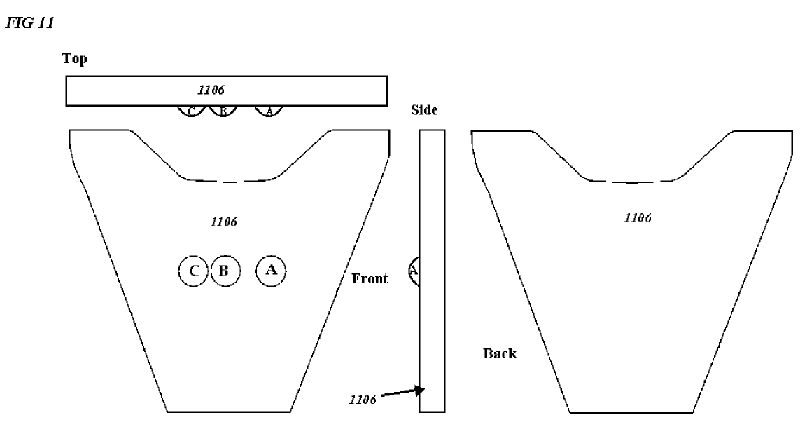

FIG. 10 shows a handheld 3D rig shaped like a yoke held up by both shoulders balanced with head in middle and is referred to as Rig #5 (“YOKE”).

FIG. 10 shows a top view, front view, a perspective view, and a side view in accordance with one or more embodiments of the invention. FIG. 10 shows a yoke made from lightweight metal like 6061 aluminum or hardened molded plastic. FIG. 10 show a battery compartment (103), which acts as a counterweight and holds batteries. FIG. 10 shows a support rod (106), which connects rig together, shoulder support (109), which supports Rig #5 on a person's shoulders. FIG. 10 shows a corner pivot joint (112) attaching point for grip arms and pivot point and a camera tube (115) enclosure for cameras, and a screw plate (118) that screws grip arms to pivot joint. FIG. 10 also shows miniball (121) small articulation point and grip arm (124) extendable arm for grip placement. Grip (127) hand hold position is used by the operator to pan and tilt the rig. In accordance with one or more embodiments of the invention, Rig #5 is MIO3-D with fixed IO having four lenses—2 convergeable and 2 fixed. Cameras may be attached to a rig or built into the rig. FIG. 10 shows Rig #5 four cameras where two are convergeable A and D and two are fixed B and C all having variable focal length. Rig #5 is intended for hand held 3-D Rig operation in dual shoulder mounted applications balanced from side to side front to back. Rig #5 uses MIO 3-D shooting convention and camera displacement shown in FIGS. 3 and 4 in accordance with one or more embodiments of the invention.

FIG. 11 is made from molded plastic enclosure (1106), involves using fixed IO multiple cameras A, B, C positioned on chest or back mounted with rig built into jacket, clothing or overhead vest like body armor shooting first person action and is referred to as Rig #6 (“CHEST RIG”) in accordance with one or more embodiments of the invention. In one embodiment of the invention, Rig #6 includes Dual-3D with three or more lenses and small, normal, wide IO distance on a fixed mounting mechanism mounted into a body armor type vest forward and/or backward. In one embodiment of the invention, Rig #6 is operated by wearer and hard mounted anywhere. Cameras may be attached to a rig or built into the rig. Rig #6 uses MIO 3-D shooting convention and camera displacement shown in FIG. 1, 2, or 3 in accordance with one or more embodiments of the invention.

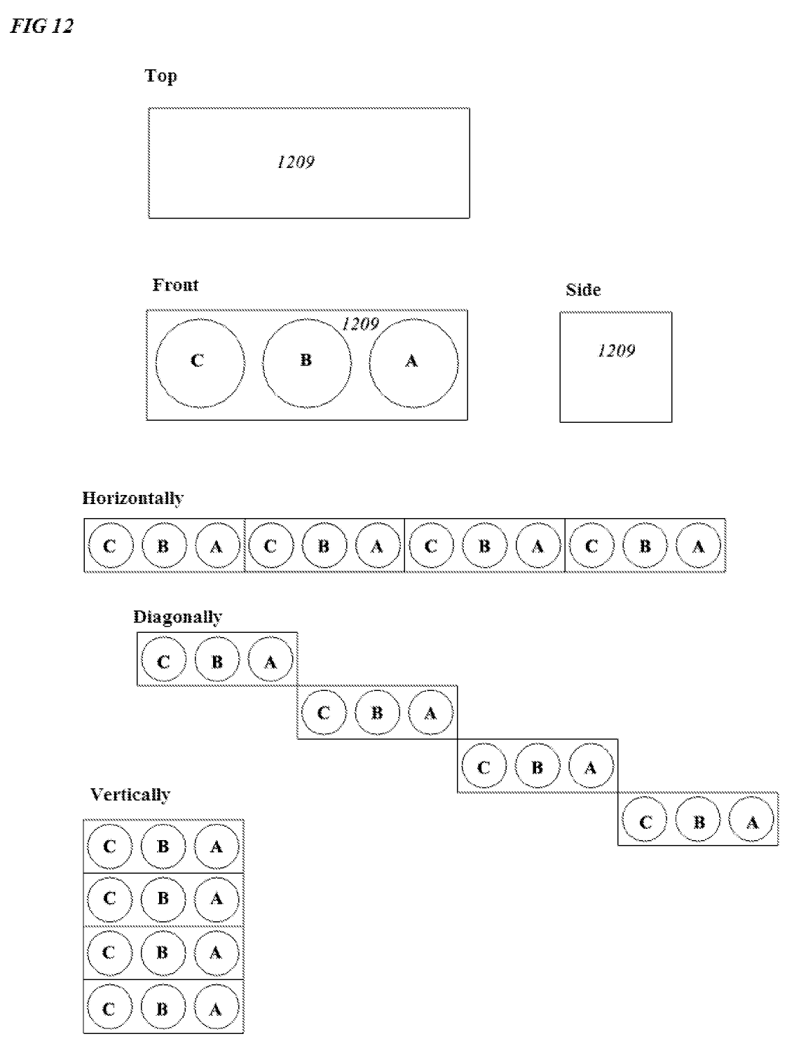

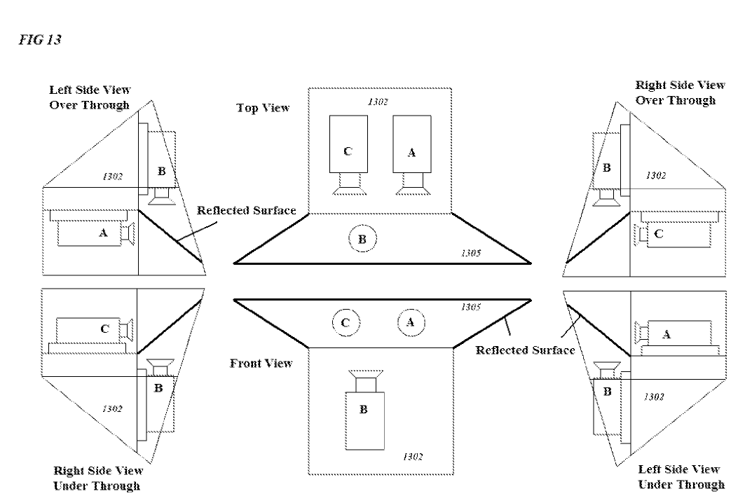

FIG. 12 shows small flexible fixed IO sections called “Links” in accordance with one or more embodiments of the invention. FIG. 12 shows a rig made from molded plastic and includes a front view, top view, and side view. FIG. 12 show link (1209) enclosure holding three cameras together connectable linked together in variable length strands vertically, horizontally, diagonally, spiral or circular and is referred to as Rig #7 (“DNA”) in accordance with one or more embodiments of the invention.

In one embodiment of the invention, Rig #7 has small multiple lens sections along a square tube or other mounting mechanism linked together to make up a flexible camera rig. In one embodiment of the invention, Rig #7 involves fixed point operation horizontally and vertically or diagonally. Cameras may be attached to a rig or built into the rig. Rig #7 uses MIO 3-D shooting convention and camera displacement shown in FIG. 1 in accordance with one or more embodiments of the invention.

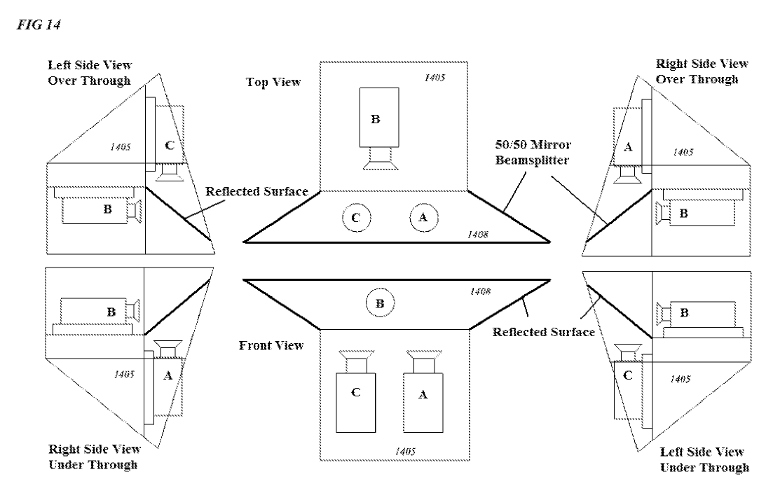

FIG. 13 shows a front view, side view, and top view of a rig made from lightweight metal such as 6061 aluminum. The rig platform (1302) shows a beamsplitter (1305) having a 50/50 mirror with two cameras mounted side by side looking through the mirror while one camera looks up or down into the reflected surface to achieve smaller IO's not possible in side by side MIO 3-D due to size of cameras in accordance with one or more embodiments of the invention. FIG. 13 is referred to as Rig #8 (“MIO 3-D Beamsplitter”). Cameras may be attached to a rig or built into the rig. Rig #8 uses MIO 3-D shooting convention and camera displacement shown in FIG. 5 in accordance with one or more embodiments of the invention.

FIG. 14 shows a front view, side view, and top view of a rig made from lightweight metal such as 6061 aluminum. The rig platform (1405) shows a beamsplitter (1408) having a 50/50 mirror with two cameras mounted side by side looking up or down into the mirror's reflected surface while one camera looks directly through the mirror to achieve smaller IO's not possible in side by side MIO 3-D due to size of the cameras in accordance with one or more embodiments of the invention. FIG. 14 is referred to as Rig #9 (“MIO 3-D Beamsplitter”). Cameras may be attached to a rig or built into the rig. Rig #9 uses MIO 3-D shooting convention and camera displacement shown in FIG. 5 in accordance with one or more embodiments of the invention.

In one or more embodiments of the invention, Rig #8 and Rig #9 use a beamsplitter mounted onto the camera rig. A beamsplitter is an optical device that splits an incoming light beam into two or more light beams. In one or more embodiments of the invention, a beamsplitter transmits approximately 50% of the light coming from an object and reflects the other 50% of the light coming from the object. In one or more embodiments of the invention, the beamsplitter may be placed at a 45 degree angle to the optical plane (i.e. 45 degrees to the direction the lenses are facing). In such embodiments, one or more lenses may be placed orthogonally to the other lenses (i.e., normal to the optical plane of the other lenses and normal to the object) and also directed at a 45 degree angle to the beamsplitter. Rig #8 has one lens mounted orthogonally to the object and two lenses directly facing the object. Rig #9 has two lenses mounted orthogonally to the object and one lens directly facing the object.

In one or more embodiments of this invention, the IO distances of lenses in a configuration utilizing a beamsplitter are determined by the distances between the optical axes of the lenses in the plane of the beamsplitter. In other words, when each lens points at a certain location on the beamsplitter, the distances between these locations determine the IO distances. In an example, the interaxial distances are determined by the distances between the lenses pointing at the object and the image of a lens pointing orthogonal to the object, viewable on the front of the beamsplitter, as shown below. Those skilled in the art will appreciate that by allowing lenses to be placed in an orthogonal configuration instead of just side-by-side may allow for smaller IO distances than would normally be possible due to the physical size of the lenses or cameras. Large lenses or cameras may be used with a beamsplitter to obtain the required IO distances than in a side-by-side configuration.

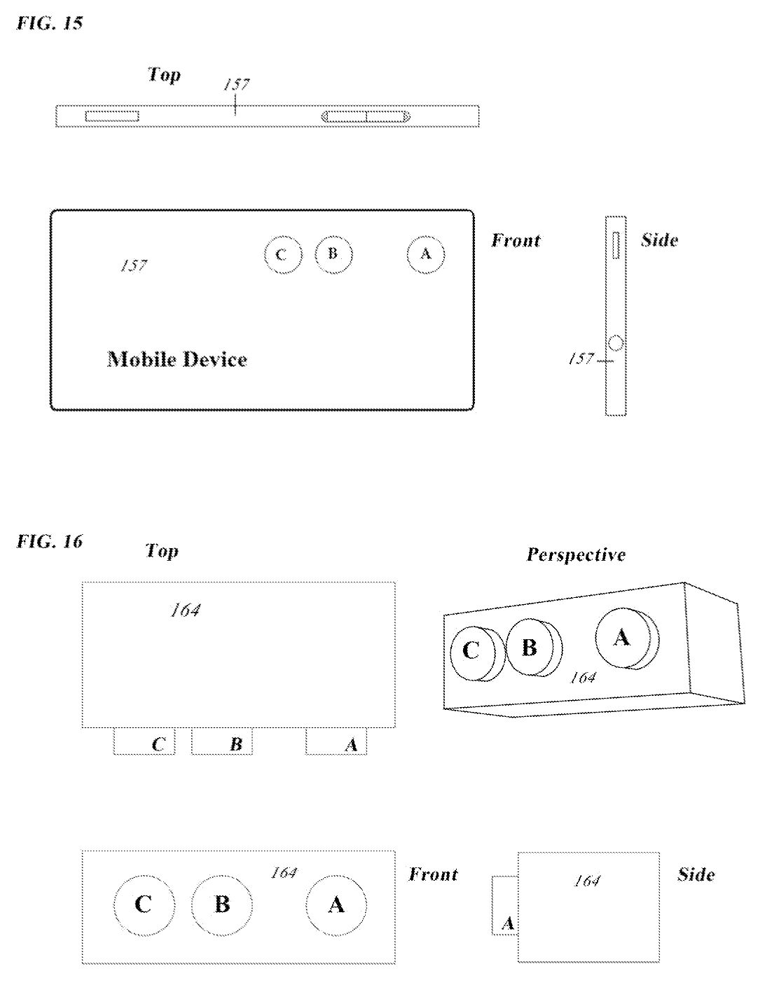

FIG. 15 shows a front view, side view, and top view of a rig made from lightweight metal such as 6061 aluminum. Mobile device (157) shows MIO 3-D integrated into any mobile device such as tablets, phones, or other portable device able to connect to wireless recorder, internet, or cellular service. FIG. 15 is referred to as Rig #10 (“MIO MOBILE”). In one embodiment of the invention, Rig #10 has three lenses mounted onto a mobile device (e.g., cell phone, PDA). The images from the three lenses may be directed to a camera integrated onto the mobile device and may be captured and digitized by the integrated camera. In one or more embodiments of the invention, the convergence of the three lenses is controllable, which allows for taking close-up pictures. In one or more embodiments of the invention, after the images are captured and digitized, the images can be edited using software running on the mobile devices and the corresponding 3-D image can be formed and displayed on the screen of the mobile device. In addition, the images will be proper for display screen sizes 40 inches and above. The 3-D image may then be distributed (e.g., via MMS or email) to other destinations or posted on a website (e.g., using a web browser and an internet connection available on the mobile device). Cameras may be built into the device.

FIG. 16 shows a front view, perspective view, side view, and top view of a model representation (164) of MIO 3-D cameras and lenses integrated into a single camera device enclosure and is referred to as Rig #11 (“MIO 3-D CAM”) in accordance with one or more embodiments of the invention. Cameras may be built into the rig as one solid enclosure as an all-in-one 3D rig with all components built inside. Rig #16 uses MIO 3-D shooting convention and camera displacement shown in FIG. 1 in accordance with one or more embodiments of the invention.

FIG. 17 shows a front view, side view, and top view of a rig made from material like 6061 aluminum. FIG. 17 show 3D MultiPlates 1×3 (1707) holds cameras to rig. 3D Multiplate 3×3 (1710) is the base plate attaching cameras and grip. Gripblock (1713) attaches grip to Multiplate 3×3. Grip (1716) is a hand grip that attaches to the gripblock allows user to hold the rig. FIG. 17 shows MIO 3-D multiple cameras A, B, C mounted to a plate or enclosure held with a grip and is referred to as Rig #12 (“HAND CAM”) in accordance with one or more embodiments of the invention. Cameras may be attached to Rig #17. Rig #17 uses MIO 3-D shooting convention and camera displacement shown in FIG. 2 in accordance with one or more embodiments of the invention.

Embodiments of the invention (or portions thereof), may interact with virtually any type of computer regardless of the platform being used. For example, a computer system includes one or more processor(s), associated memory (e.g., random access memory (RAM), cache memory, flash memory, etc.), a storage device (e.g., a hard disk, an optical drive such as a compact disk drive or digital video disk (DVD) drive, a flash memory stick, etc.), and numerous other elements and functionalities typical of today's computers (not shown). The computer system may also include input means, such as a keyboard, a mouse, or a microphone. Further, the computer system may include output means, such as a monitor (e.g., a liquid crystal display (LCD), a plasma display, or cathode ray tube (CRT) monitor). The computer system may be connected to a network (e.g., a local area network (LAN), a wide area network (WAN) such as the Internet, or any other similar type of network) with wired and/or wireless segments via a network interface connection (not shown). Those skilled in the art will appreciate that many different types of computer systems exist, and the aforementioned input and output means may take other forms. Generally speaking, the computer system includes at least the minimal processing, input, and/or output means necessary to practice one or more particular embodiments of business driven training and qualifications (or portions thereof).

Further, those skilled in the art will appreciate that one or more elements of the aforementioned computer system may be located at a remote location and connected to the other elements over a network. Further, one or more embodiments may be implemented on a distributed system having multiple nodes, where each portion may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions for performing one or more embodiments of business driven training and qualifications may be stored in the cloud on a computer readable medium such as a compact disc (CD), a diskette, a tape, or any other computer readable storage device.

In one or more embodiments of the invention, any rig described above may include three or more lenses located along a rig, tube or other mounting mechanism with three or more lens distances (i.e. the distance between any two lenses) may range from as small as 0.001 mm to 10,000 meters in separation. And may not be attached to the same surface or device, but will serve as image gathering tool to make a single 3D image.

It will be understood from the foregoing description that various modifications and changes may be made in the preferred and alternative embodiments of the invention without departing from its true spirit. This description is intended for purposes of illustration only and should not be construed in a limiting sense. While the invention has been described with respect to a limited number of embodiments, those skilled in the art, having benefit of this disclosure, will appreciate that other embodiments can be devised which do not depart from the invention as disclosed herein. Accordingly, the scope of the invention should be limited only by the attached claims.

What is claimed is:

1. A three-dimensional camera rig, comprising:
a plurality of lenses located along a mounting mechanism,
wherein the plurality of lenses are separated at an interocular distance along the mounting mechanism necessary to capture a three-dimensional image capable of distribution, and
wherein the three-dimensional image is viewable in a plurality of formats.

2. The three-dimensional camera rig of claim 1, wherein the three-dimensional image is video content.

3. A three-dimensional camera rig, comprising:
a rigid mounting mechanism; and
three or more lenses mounted on the rigid mounting mechanism at multiple interaxial distances and configured to capture a three dimensional image capable of distribution.

4. The three-dimensional camera rig of claim 3, wherein the three-dimensional image is viewable from a plurality of stereo pairs of fields of view.

5. The three-dimensional camera rig of claim 4, wherein the plurality of stereo pairs of fields of view is obtained from images captured by a distinct pair of lenses of the three or more lenses.

6. The three-dimensional camera rig of claim 3, wherein the three-dimensional image is viewable in a plurality of display sizes.

7. The three-dimensional camera rig of claim 3, wherein the three-dimensional image is viewable on a screen in a plurality of scene depths.

8. The three-dimensional camera rig of claim 3,
wherein the three or more lenses comprises a first pair of lenses having a first convergence distance,
wherein the three of more lenses comprises a second pair of lenses having a second convergence distance, and
wherein the three-dimensional image is viewable with a first convergence distance and with a second convergence distance.

9. The three-dimensional camera rig of claim 3, further comprising:
a beamsplitter mounted on the rigid mounting mechanism and configured to split a light beam coming from an object into a reflected component and a transmitted component,
wherein a first lens of the three or more lenses captures the reflected component, and
wherein a second lens of the three or more lenses captures the transmitted component.

10. The three-dimensional camera rig of claim 9, wherein the beamsplitter splits the reflected component 90 degrees away from the transmitted component, and wherein the first lens of the three or more lenses is mounted orthogonally to the second lens of the three or more lenses.

11. A method for capturing a three-dimensional image comprising:
preparing a three-dimensional camera rig comprising three or more lenses mounted on a rigid mounting mechanism at multiple interaxial distances,
capturing, using the three or more lenses, a three dimensional image capable of distribution.

12. The method of claim 11, further comprising:
identifying a plurality of fields of view of the three dimensional image, wherein each field of view of the plurality of fields of view corresponds to each pair of lenses of the three or more lenses;
identifying a desired field of view of the plurality of fields of view for a scene; and
selecting for display the desired field of view of the three-dimensional image.

13. The method of claim 11, further comprising:
identifying a screen size for displaying the three-dimensional image;
selecting a pair of lenses of the three or more lenses with an interocular distance compatible with the screen size;
selecting images from the pair of lenses to form the three-dimensional image

14. The method of claim 11, further comprising:
identifying a plurality of scene depths of the three dimensional image, wherein each scene depth of the plurality of scene depths corresponds to each pair of lenses of the three or more lenses;
identifying a desired scene depth of the plurality of scene depths for a portion of a scene; and
selecting for display the desired scene depth of the three-dimensional image.

15. The method of claim 11, wherein the first lens and the second lens have a first convergence distance, wherein the second lens and the third lens have a second convergence distance, and wherein the three-dimensional image is viewable with a first convergence distance and with a second convergence distance.

16. The method of claim 11, wherein the three-dimensional image is video content.

17. The method of claim 11, further comprising:
mounting a beamsplitter on the camera rig to split a light beam coming from an object into a reflected component and a transmitted component, wherein at least one lens of the three or more lenses captures the reflected component.

18. The method of claim 11, further comprising:
editing the three-dimensional image prior to distribution.
